(19) United States
(12) Patent Application Publication
(10) Pub. No.: US 2023/0111120 A1
(43) Pub. Date: Apr. 13, 2023

(54) ALTERNATE OPERATING SYSTEMS

(71) Applicant: HEWLETT-PACKARD DEVELOPMENT COMPANY, L.P., SPRING, TX (US)

(72) Inventors: MILIND D THAKRE, SPRING, TX (US); VALIUDDIN ALI, SPRING, TX (US); MICHAEL ANTHONY PROVENCHER, SPRING, TX (US); KARTHICK PERIYAKULAM THARAKRAJ, SPRING, TX (US)

(21) Appl. No.: 17/905,356

(22) PCT Filed: Mar. 27, 2020
(86) PCT No.: PCT/US20/25172

§ 371 Date: Aug. 31, 2022

(51) Int. Cl. G06F 9/4401

(52) U.S. Cl. CPC G06F 9/441

(57) ABSTRACT

In example implementations, a computing device is provided. The computing device includes abasic input/output system (BIOS), a first storage device to store a first operating system (OS), a second storage device to store an alternate OS that is accessible by the BIOS, a volatile memory, and a processor. The processor is in communication with the BIOS, the first storage device, the second storage device, and the volatile memory. In response to a determination that the first OS is unavailable, the processor is to cause the IOS to load the alternate OS from the second storage device into the volatile memory, disable access to the first storage device, and cause the BIOS to execute the alternate OS from the volatile memory.

### BACKGROUND

Computing devices help provide productivity. The computing systems can execute programs, process data, and the like, for a variety of different applications. The computing devices may use an operating system as a host environment to execute the programs and processes.

In some instances, the operating system may fail. The operating system may fail due to a corrupt hard disk drive or a malware attack on the computing device. Without the operating system the computing device may not be able to function properly.

### BRIEF DESCRIPTION OF THE DRAWINGS

FIG. 1 is a block diagram of an example apparatus with an alternate operating system of the present disclosure;

FIG. 2 is a more detailed block diagram of an example apparatus with an alternate operating system of the present disclosure;

FIG. 3 is a flow chart of an example method for booting an alternate operating system of the present disclosure when an operating system fails;

FIG. 4 is an example non-transitory computer readable storage medium storing instructions executed by a processor to boot an alternate operating system of the present disclosure; and

FIG. 5 is another example non-transitory computer readable storage medium storing instructions executed by a processor to boot an alternate operating system of the present disclosure.

### DETAILED DESCRIPTION

Examples described herein provide a computing device with a secure alternate operating system. As discussed above, computing devices use operating systems as host environments to execute programs and processes. When the operating system fails, the computing device may not be able to function properly. In other instances, the computing device may be repaired or modified such that the operating system on the main storage device is not available.

The present disclosure provides a secure alternate operating system that can be booted when the main operating system is unavailable (e.g., due to failure or user selection). In an example, policies can be stored that indicate when the alternate operating system should be used and additional security measures that can be taken while the alternate operating system is being used.

The alternate operating system can be stored in a secure memory of the basic input/output system (BIOS) and loaded into volatile memory (e.g., random access memory (RAM)) of the computing device. The alternate operating system can allow the user to access some functionality while the main operating system is repaired. Once the main operating system is available, the volatile memory can be purged and the main operating system can be executed again on the computing device.

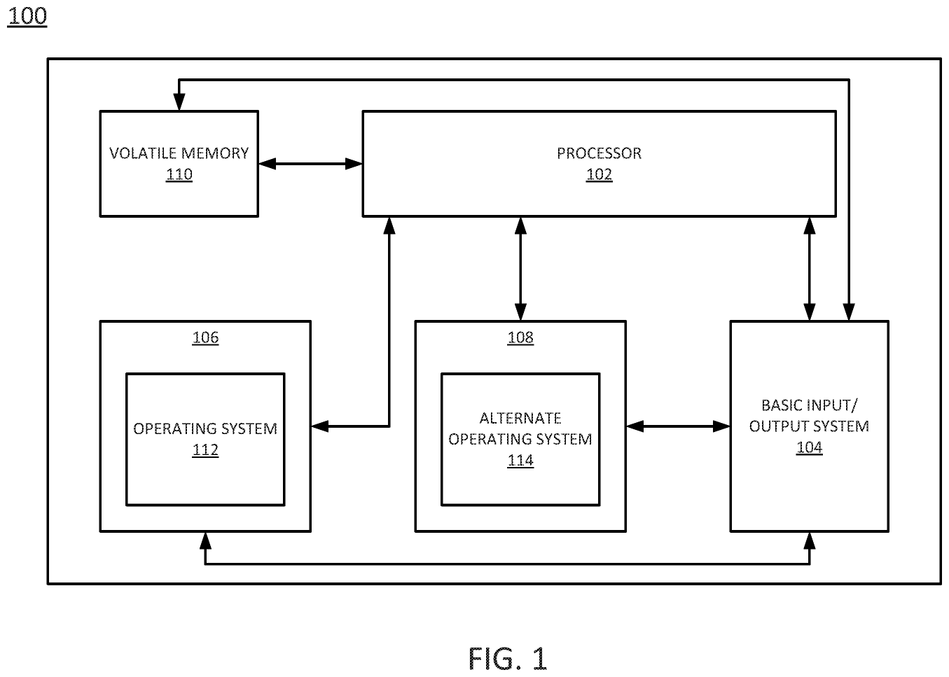

FIG. 1 illustrates an example apparatus 100 of the present disclosure that may include an alternate operating system 114 that can be booted when an operating system (OS) 112 fails. In an example, the apparatus 100 may be a computing device. For example, the apparatus 100 may be a desktop computer, a laptop computer, a tablet computer, and the like. It should be noted that the apparatus 100 has been simplified for ease of explanation and may include additional components that are not shown. For example, the apparatus 100 may include external input/output interfaces (e.g., universal serial bus (USB) interfaces), input/output devices (e.g., a keyboard, a mouse, a touchpad, a display), power supplies, other integrated circuits, and the like.

In an example, the apparatus 100 may include a processor 102, a basic input/output system (BIOS) 104, a first storage device 106, a second storage device 108, and a volatile memory 110. The processor 102 may be communicatively coupled to the BIOS 104, the first storage device 106, the second storage device 108, and the volatile memory 110. The processor 102 may control operation of the BIOS 104, the first storage device 106, the second storage device 108, and the volatile memory 110.

In an example, the BIOS 104 may be communicatively coupled to the first storage device 106, the second storage device 108, and the volatile memory 110. The BIOS 104 may have access to the first storage device 106, the second storage device 108, and the volatile memory 110 to load and/or delete data, as discussed in further details below.

As used herein, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

In an example, the first storage device 106 may be a non-transitory computer readable medium. The first storage device 106 may be a hard disk-drive, a solid state drive, an external hard-disk drive, and the like. The first storage device 106 may store the OS 112. The OS 112 may be a primary or main OS that is booted by the BIOS 104 and executed by the processor 102.

In an example, the second storage device 108 may be a non-transitory computer readable medium. The second storage device 108 may be a secure storage device that can be accessed by the BIOS 104. The second storage device 108 may be a secure partition of the first storage device 106 or may be a separate storage device (e.g., an embedded multimedia card).

The second storage device 108 may include an alternate OS 114. The alternate OS 114 may be a copy of the OS 112 or a different type of OS. As discussed in further details herein, when the OS 112 is unavailable (e.g., due to failure, malicious attack, or by user decision), the alternate OS 114 may be accessed from the second storage device 108 and loaded into the volatile memory 110. The BIOS 104 may boot the alternate OS 114 from the volatile memory 110 and the processor 102 may execute the alternate OS 114 until the OS 112 is available again.

Storage of the alternate OS 114 in the second storage device 108 may provide a manner in which the alternate OS 114 may not be easily removed, erased, modified, or compromised. Thus, the second storage device 108 may provide a dependable mechanism for the alternate OS 114 to be available so that the apparatus 100 can be booted even when the OS 112 is unavailable.

In an example, the volatile memory 110 may be a non-transitory computer readable medium such as a random access memory (RAM). The volatile memory 110 may temporarily store the alternate OS 114 when the OS 112 fails. When the OS 112 is available again and booted by the BIOS 104, the volatile memory 110 may be purged of the alternate OS 114 and any data associated with the alternate OS 114.

As noted above, the OS 112 may be unavailable. For example, the OS 112 may fail during operation of the apparatus 100. The failure may be due to a software error. For example, the OS 112 may be corrupted or attacked by malware or a virus. The failure may be due to hardware failure. For example, the first storage device 106 may fail.

In an example, the OS 112 may be unavailable based on user decision. For example, the user may temporarily disable the OS 112 for maintenance or any other reason. For example, the user may selectively enter an alternate OS mode so that the OS 112 can be updated, changed, upgraded, and the like, while allowing the user to still be productive using the apparatus 100. In an example, the user may be using the apparatus 100 in an environment that is not secure. So the user may choose to load the alternate OS 114 instead of the OS 112. In an example, there may be a dual use case where the application uses full isolation of two operating systems (e.g., both the OS 112 and the alternate OS 114). In an example, the user may be executing a high security or restricted application that should be executed in the alternate OS 114 rather than the OS 112.

When the failure or unavailability of the OS 112 is detected, the BIOS 104 may access the second storage device 108. The BIOS 104 may copy the alternate OS 114 to the volatile memory 110. The apparatus 100 may be restarted and the BIOS 104 may boot the alternate OS 114 from the volatile memory 110. The processor 102 may then execute the alternate OS 114 from the volatile memory 110.

In an example, the alternate OS 114 may provide a subset of applications and/or functionality of the OS 112. For example, the alternate OS 114 may include email, a web browser, and some productivity applications (e.g., word processing applications, spreadsheet applications, presentation applications, and the like). In other words, the alternate OS 114 may not be intended to provide a complete replacement of the OS 112. Rather, the alternate OS 114 may provide enough functionality to allow a user to be productive while the OS 112 is temporarily disabled.

In an example, access to the first storage device 106 by the alternate OS 114 may be disabled. Disabling access to the first storage device 106 may prevent any incoming data from the alternate OS 114 from further corrupting the OS 112 in the first storage device 106. Thus, the alternate OS 114 may provide a secure OS while the OS 112 is repaired or re-booted.

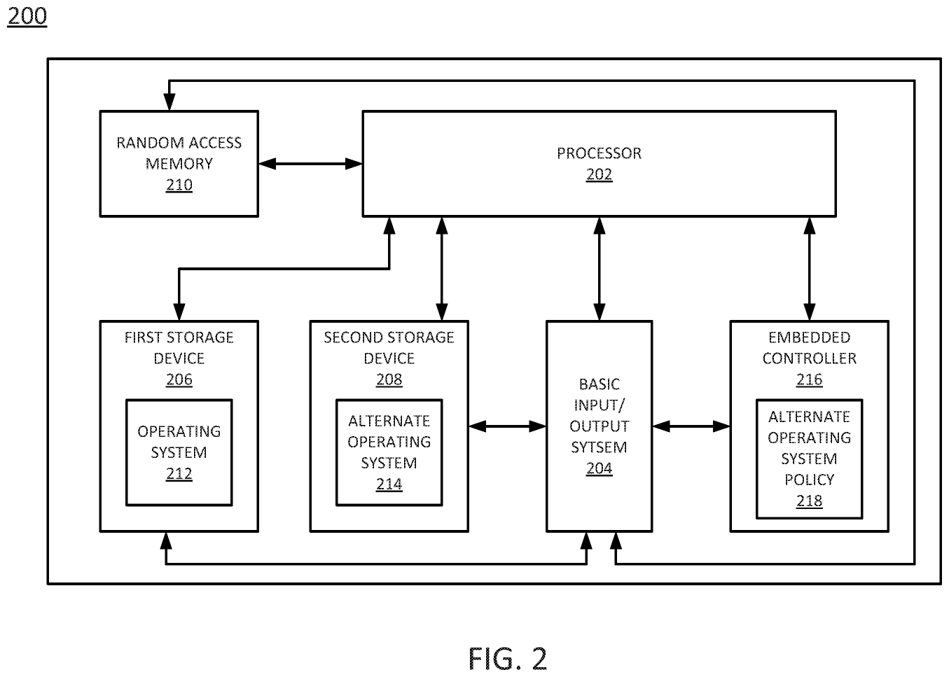

In an example, the operation of the various hardware (e.g., the first storage device 106, the second storage device 108, external interfaces, and the like) may be controlled in accordance with a policy based on a cause of the failure of the OS 112. Examples of the policy are illustrated in FIG. 2 and discussed in further details below.

When the OS 112 is available again, the processor 102 may reboot the apparatus 100. The BIOS 104 may boot the OS 112 from the first storage device 106. When the OS 112 is successfully booted, the BIOS 104 may purge the copy of the alternate OS 114 from the volatile memory 110. In other words, the copy of the alternate OS 114 and any data associated with the alternate OS 114 may be deleted from the volatile memory 110. Thus, the apparatus 100 may provide a secure alternate OS 114 when the OS 112 fails.

FIG. 2 illustrates another example apparatus 200 of the present disclosure that may include an alternate OS 214 that can be booted when an OS 212 fails. In an example, the apparatus 200 may be a computing device. For example, the apparatus 200 may be a desktop computer, a laptop computer, a tablet computer, and the like. It should be noted that the apparatus 200 has been simplified for ease of explanation and may include additional components that are not shown. For example, the apparatus 200 may include external input/output interfaces (e.g., universal serial bus (USB) interfaces), input/output devices (e.g., a keyboard, a mouse, a touchpad, a display), power supplies, other integrated circuits, and the like.

In an example, the apparatus 200 may include a processor 202, a basic input/output system (BIOS) 204, a first storage device 206, a second storage device 208, a random access memory (RAM) 210, and an embedded controller 216. The processor 202 may be communicatively coupled to the BIOS 204, the first storage device 206, the second storage device 208, the RAM 210, and the embedded controller 216. The processor 202 may control operation of the BIOS 204, the first storage device 206, the second storage device 208, the RAM 210, and the embedded controller 216.

In an example, the BIOS 204 may be communicatively coupled to the first storage device 206, the second storage device 208, the RAM 210, and the embedded controller 216. The BIOS 104 may have access to the first storage device 206, the second storage device 208, the RAM 210, and the embedded controller 216 to access, load, and/or delete data, as discussed in further details below.

In an example, the first storage device 206 may be a primary storage device of the apparatus 200. For example, the first storage device 206 may be a hard disk drive or solid state drive of the apparatus 200. The first storage device 206 may store the OS 212. The OS 212 may be a first OS or default OS. In other words, when the apparatus 100 is functioning without error, the OS 212 may be booted and applications stored in the first storage device 206 may be executed within the OS 212 by the processor 202.

In an example, the second storage device 208 may comprise a combination of flash memory and a controller. The second storage device 208 may be a secure storage device that is accessible by the BIOS 204. For example, the second storage device may be an embedded multi-media memory card (EMMC). The second storage device 208 may store the alternate OS 214.

The RAM 110 may temporarily store the alternate OS 214 when the OS 212 fails. When the OS 212 is available again and booted by the BIOS 204, the RAM 210 may be purged of the alternate OS 214 and any data associated with the alternate OS 214.

In an example, the embedded controller 216 may be a controller that may act as a bridge between the BIOS 204 and the processor 202 for various tasks. In an example, the embedded controller 216 may include memory and store an alternate OS policy 218. The alternate OS policy 218 may include rules that are implemented depending a reason or a cause of the failure of the OS 212. For example, the alternate OS policy 218 may store security instructions that are implemented when the OS 212 is unavailable due to a failure.

For example, if the OS 212 is unavailable due to a failure caused by a software attack, malfunction, or corruption, the security instructions in the alternate OS policy 218 may indicate that access to the first storage device 206 should be disabled. For example, the applications that are executed by the alternate OS 214 from the RAM 210 may not be able to have access to the first storage device 206.

In an example, the alternate OS policy 218 may also store controls to ensure that a proper user is loading the alternate OS 214. For example, the alternate OS policy 218 may store a security parameters. The security parameters may include a certain combination of key sequences when the alternate OS 214 is booting or at runtime, a password, a pin, a cryptographic challenge, and the like.

In another example, if the OS 212 is unavailable due to a user input (e.g., the user selectively launches the alternate OS 214 to repair or upgrade the OS 212), then alternate OS policy 218 may indicate that access to the first storage device 206 may be enabled. For example, the alternate OS policy 218 may allow partial functionality of the first storage device 206. For example, some data from applications may be stored in the first storage device 206. The data may be applications executed in the alternate OS 214. For example, a file stored in the first storage device 206 may be read from an application executed in the alternate OS 214. In other examples, if the OS 212 is unavailable due to user selection, the alternate OS policy 218 may allow access to the second storage device 208 to modify the alternate OS 214, allow access to some external interfaces (e.g., allow an external storage device to be connected), and the like.

As noted above, the OS 212 may fail during operation of the apparatus 200. When the failure is detected, the BIOS 204 may access the second storage device 208. The BIOS 204 may copy the alternate OS 214 to the RAM 210. The apparatus 200 may be restarted and the BIOS 204 may boot the alternate OS 214 from the RAM 210. The processor 202 may then execute the alternate OS 214 from the RAM 210.

In an example, the cause of the failure may be determined. The BIOS 204 may access the alternate OS policy 218 stored in the embedded controller 216. The BIOS 204 may then change an operation of hardware devices of the apparatus 200 in accordance with the alternate OS policy 218 based on the cause of the failure of the OS 212.

The alternate OS policy 218 may indicate to have the BIOS 204 disable access to the first storage device 206 due to a malware attack or failure of the first storage device 206. In other examples, the alternate OS policy 218 may indicate to allow limited access to the first storage device 206 if the failure of the OS 212 is due to a user input (e.g., the user selectively booted the alternate OS 214). For example, the first storage device 206 may operate in a read only mode or allow limited data from certain applications in the alternate OS 214 to be stored on the first storage device 206.

In an example, the alternate OS 214 may provide a subset of applications and/or functionality of the OS 212. For example, the alternate OS 214 may include email, a web browser, and some productivity applications (e.g., word processing applications, spreadsheet applications, presentation applications, and the like). In other words, the alternate OS 214 may not be intended to provide a complete replacement of the OS 212. Rather, the alternate OS 214 may provide enough functionality to allow a user to be productive while the OS 212 is temporarily disabled.

When the OS 212 is available again, the processor 202 may reboot the apparatus 200. The BIOS 204 may boot the OS 212 from the first storage device 206. When the OS 212 is successfully booted, the BIOS 204 may purge the copy of the alternate OS 214 from the RAM 210. In other words, the copy of the alternate OS 214 and any data associated with the alternate OS 214 may be deleted from the RAM 210. Thus, the apparatus 200 may provide a secure alternate OS 214 when the OS 212 fails.

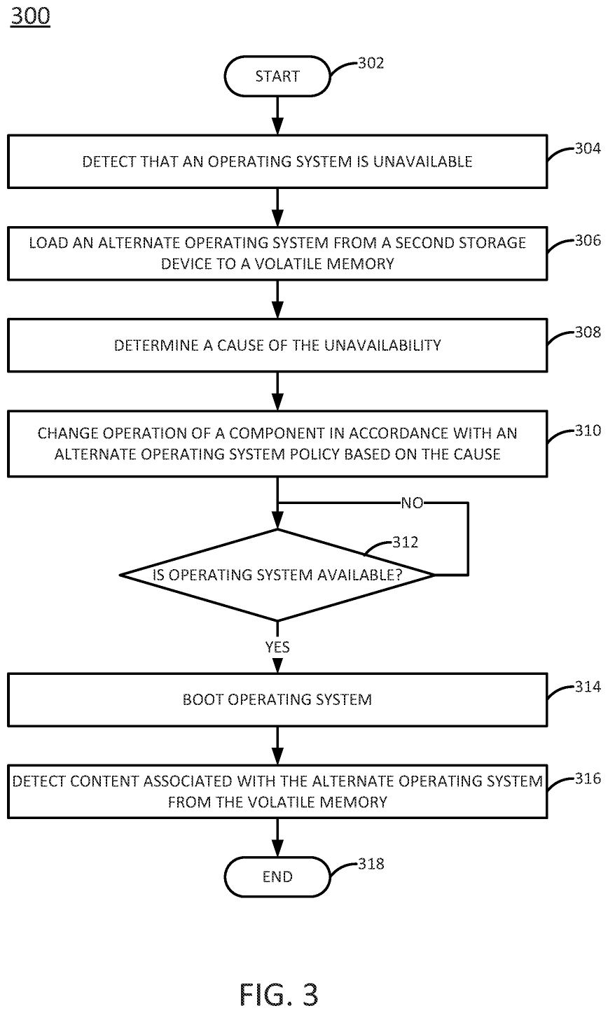

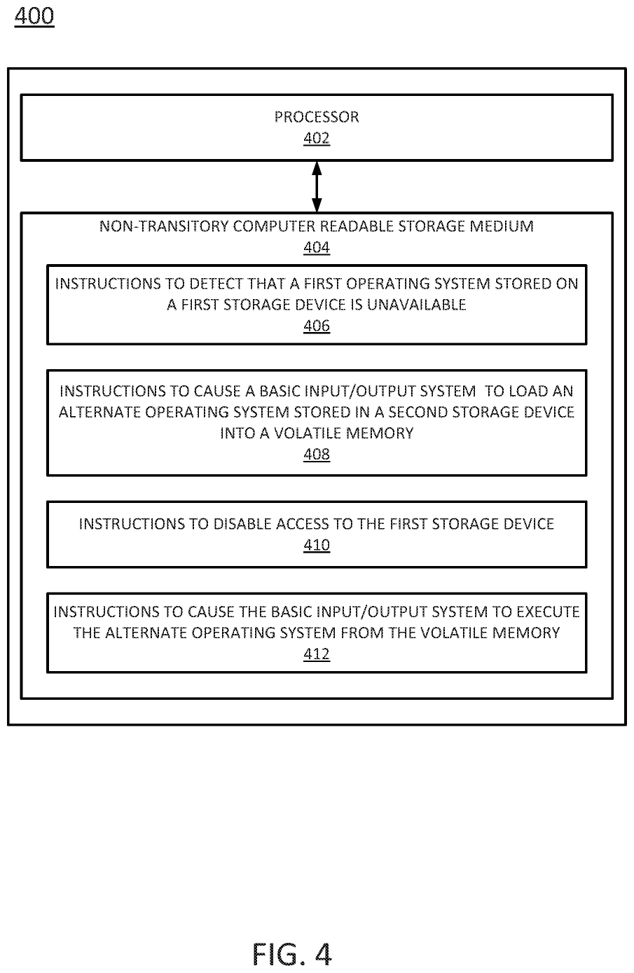

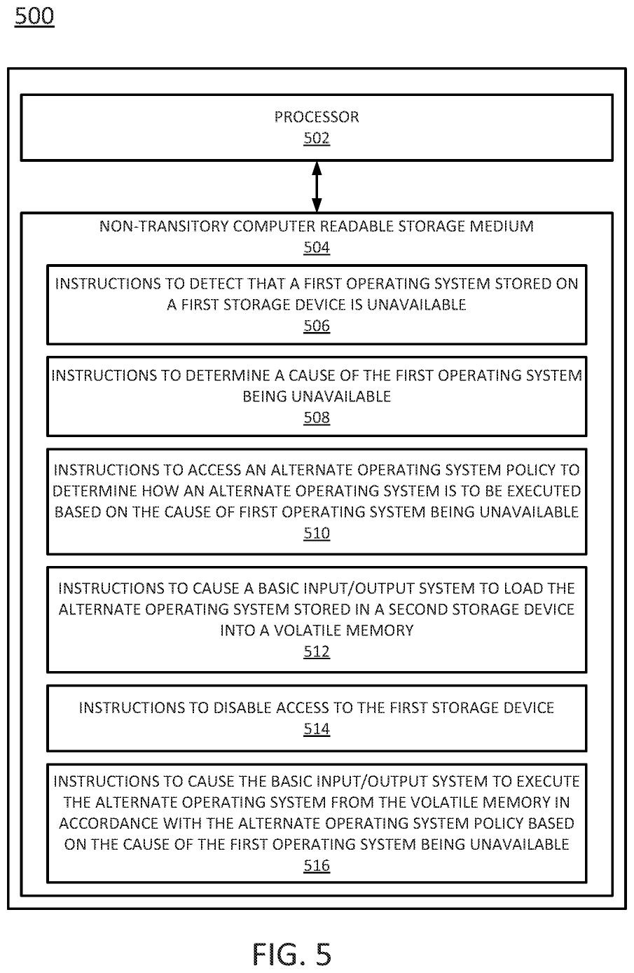

FIG. 3 illustrates a flow diagram of an example method 300 for booting an alternate operating system of the present disclosure when an operating system fails. In an example, the method 300 may be performed by the apparatus 100 or 200, the apparatus 400 illustrated in FIG. 4, and described below, or the apparatus 500 illustrated in FIG. 5, and described below.

At block 302, the method 300 begins. At block 304, the method 300 detects that an operating system (OS) is unavailable. For example, the OS may be a primary OS of the apparatus or computing device. The OS may fail to boot for a variety of reasons. For example, the OS may be corrupted, may be under a malware attack, the storage device storing the OS may fail, the user may choose to boot an alternate OS, and so forth.

At block 306, the method 300 loads an alternate OS from a second storage device to a volatile memory. In one example, the alternate OS may be stored in a secure storage device. For example, the second storage device may be an embedded multimedia card (EMMC) that is accessible by the BIOS. The BIOS may copy the alternate OS stored in the secure storage device and load a copy of the alternate OS in the volatile memory. The volatile memory may be a random access memory (RAM) of the apparatus. The BIOS may then restart the apparatus and boot the alternate OS from the volatile memory.

In an example, the alternate OS may provide some functionality or allow some applications to be executed while the OS is unavailable. For example, the alternate OS may include an email application, a web browser, some productivity applications, and the like. Thus, a user may be able to access the Internet, check emails, create or work on documents, and so forth, while the OS is unavailable.

At block 308, the method 300 determines a cause of the unavailability of the OS. For example, other hardware components of the apparatus may be controlled based on the cause of the unavailability of the OS. If the unavailability was caused by a failure due to malicious attack, then access to other hardware devices can be disabled. However, if the unavailability was caused by a user input (e.g., the user selected to boot the alternate OS), then hardware devices can be enabled to provide limited access.

At block 310, the method 300 changes operation of a component in accordance with an alternate OS policy based on the cause. For example, if the cause was due to a malicious attack, access to storage devices may be disabled for security. Thus, any incoming data may not be able to reach persistent storage devices. In addition, input interfaces may also be disabled. For example, the user may not be able to access external storage devices when operating in the alternate OS.

In other examples, if the unavailability was due to a user input, then some limited access may be granted to the primary storage device or hard disk drive where the OS is stored. For example, the primary storage device storing the OS may be operated in a read only mode. In other examples, some data obtained in the alternate OS may be stored in the primary storage device or files generated by applications in the alternate OS may be stored in the primary storage device.

At block 312, the method 300 determines if the OS is available. If the OS is not available, then the method 300 loops back to 312 until the OS is available. When the OS is available, the method 300 proceeds to block 314.

At block 314, the method 300 boots the OS. For example, when the OS is available again, the BIOS may restart the apparatus and boot the OS from the storage device that stores the OS.

At block 316, the method 300 deletes content associated with the alternate OS from the volatile memory. For example, when the OS is successfully booted, the BIOS may purge the volatile memory of the alternate OS and any data associated with the alternate OS. The content associated with the alternate OS may include any cookies from web browsers, temporary data stored in memory caches or the web browser, information stored on a clip board for an application, temporarily stored downloads, and the like. At block 318, the method 300 ends.

FIG. 4 illustrates an example of an apparatus 400. In an example, the apparatus 400 may be the apparatus 100 or 200. In an example, the apparatus 400 may include a processor 402 and a non-transitory computer readable storage medium 404. The non-transitory computer readable storage medium 404 may include instructions 406, 408, 410, and 412 that, when executed by the processor 402, cause the processor 402 to perform various functions.

In an example, the instructions 406 may include instructions to detect that a first operating system (OS) stored on a first storage device is unavailable. The instructions 408 may include instructions to cause a basic input/output system (BIOS) to load an alternate OS stored in a second storage device into a volatile memory. The instructions 410 may include instructions to disable access to the first storage device. The instructions 412 may include instructions to cause the BIOS to execute the alternate OS from the volatile memory.

FIG. 5 illustrates an example of an apparatus 500. In an example, the apparatus 500 may be the apparatus 100 or 200. In an example, the apparatus 500 may include a processor 502 and a non-transitory computer readable storage medium 504. The non-transitory computer readable storage medium 504 may include instructions 506, 508, 510, 512, 514, and 516 that, when executed by the processor 502, cause the processor 502 to perform various functions.

In an example, the instructions 506 may include instructions to detect that a first operating system (OS) stored on a first storage device is unavailable. The instructions 508 may include instructions to determine a cause of the first OS being unavailable. The instructions 510 may include instructions to access an alternate OS policy to determine how an alternate OS is to be executed based on the cause of first OS being unavailable. The instructions 512 may include instructions to cause a basic input/output system (BIOS) to load the alternate OS stored in a second storage device into a volatile memory. The instructions 514 may include instructions to disable access to the first storage device. The instructions 516 may include instructions to cause the BIOS to execute the alternate OS from the volatile memory in accordance with the alternate OS policy based on the cause of the first OS being unavailable.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A computing device, comprising:
a basic input/output system (BIOS);
a first storage device to store a first operating system (OS);
a second storage device to store an alternate OS that is accessible by the BIOS;
a volatile memory; and
a processor in communication with the BIOS, the first storage device, the second storage device, and the volatile memory, wherein in response to a determination that the first OS is unavailable the processor is to:
cause the BIOS to load the alternate OS from the second storage device into the volatile memory;
disable access to the first storage device; and
cause the BIOS to execute the alternate OS from the volatile memory.

2. The computing device of claim 1, wherein the processor is further to:
detect that the first OS is available;
cause the BIOS to boot the computing device with the first OS; and
cause the BIOS to delete contents of the volatile memory when the first OS is booted.

3. The computing device of claim 1, wherein the processor is further to:
restart the computing device before the BIOS is to execute the alternate OS from the volatile memory.

4. The computing device of claim 1, wherein the second storage device comprises an embedded multimedia card.

5. The computing device of claim 1, wherein the volatile memory comprises a random access memory (RAM).

6. The computing device of claim 1, further comprising:
an embedded controller to store an alternate OS policy.

7. The computing device of claim 6, wherein the alternate OS policy comprises security instructions when the alternate OS is executed based on whether the first OS was unavailable due to failure or disabled by a user input.

8. A non-transitory computer readable storage medium encoded with instructions executable by a processor of a computing device, the non-transitory computer-readable storage medium comprising:
instructions to detect that a first operating system (OS) stored on a first storage device of the computing device is unavailable;
instructions to cause a basic input/output system (BIOS) to load an alternate OS stored in a second storage device of the computing device into a volatile memory;
instructions to disable access to the first storage device; and
instructions to cause the BIOS to execute the alternate OS from the volatile memory.

9. The non-transitory computer readable storage medium of claim 8, further comprising:
instructions to detect that the first OS is available;
instructions to cause the BIOS to boot the computing device with the first OS; and
instructions to cause the BIOS to delete contents of the volatile memory when the first OS is booted.

10. The non-transitory computer readable storage medium of claim 8, further comprising:
instructions to determine whether the first OS is unavailable due to failure or disabled by a user input; and
instructions to enable partial functionality of the first storage device in accordance with an alternate OS policy based on whether the first OS is unavailable due to failure or disabled by a user input.

11. The non-transitory computer readable storage medium of claim 8, further comprising:
instructions to disable the first storage device after the alternate OS is loaded into the volatile memory.

12. A non-transitory computer readable storage medium encoded with instructions executable by a processor, the non-transitory computer-readable storage medium comprising:
instructions to detect that a first operating system (OS) stored on a first storage device is unavailable;
instructions to determine a cause of the first OS being unavailable;
instructions to access an alternate OS policy to determine how an alternate OS is to be executed based on the cause of first OS being unavailable;
instructions to cause a basic input/output system (BIOS) to load the alternate OS stored in a second storage device into a volatile memory;
instructions to disable access to the first storage device; and
instructions to cause the BIOS to execute the alternate OS from the volatile memory in accordance with the alternate OS policy based on the cause of the first OS being unavailable.

13. The non-transitory computer readable storage medium of claim 12, wherein the cause of the first OS being unavailable is due to a failure and the non-transitory computer-readable storage medium further comprises:
instructions to disable the first storage device.

14. The non-transitory computer readable storage medium of claim 12, wherein the cause of the first OS being unavailable is due to a user selection and the non-transitory computer-readable storage medium further comprises:
instructions to operate the first storage device in a read only mode.

15. The non-transitory computer readable storage medium of claim 12, further comprising:
instructions to delete contents of the volatile memory when first OS is available and executed by the BIOS.
